(19) United States
(12) Patent Application Publication
(10) Pub. No.: US 2014/0358962 A1
(43) Pub. Date: Dec. 4, 2014

(54) RESPONSIVE INPUT ARCHITECTURE

(71) Applicant: Microsoft Corporation, Redmond, WA (US)

(72) Inventors: Tim Wantland, Bellevue, WA (US); Christian Colando, Seattle, WA (US); Donald A. Barnett, Monroe, WA (US); Niraj Gandhi, Redmond, WA (US); Sameeksha Subhedar, Redmond, WA (US)

(21) Appl. No.: 13/909,573

(22) Filed: Jun. 4, 2013

(51) Int. Cl. G06F 17/30

(52) U.S. Cl. CPC G06F 17/30979
USPC 707/769

(57) ABSTRACT

A responsive input architecture that provides an intuitive and consistent layout and organization for search input across many different types of user devices. The architecture provides user interface consistency for all devices thereby enabling a user to seamlessly resume a search for information started on one device, on another user device. A user interface is provided that presents personalized past, present, and future aspects related to a search, while the user is entering the query, which are represented in the user interface with the past aspect as a top interactable portion (a historical listing), the present aspect as a middle interactable portion (a query entry field) and the future aspect as a bottom interactable portion (a suggestion listing). A backend system provides auto-suggestions for the user interface.

### BACKGROUND

Tasks and end goals of users when using search often extend over long periods of time and multiple device usage. A user may be planning a trip for months before making final decisions on where to stay, what all to do, etc. Search history and automatically-generated suggestions (“auto-suggestions”) need to be easily and readily accessible in a consistent manner on all devices of a user so that the user has the ability to discover and rediscover information easily without having to relearn interfaces and how information is organized.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a responsive input architecture that provides an intuitive and consistent layout and organization for search input across many different types of user devices. The architecture provides user interface consistency for all devices thereby enabling a user to seamlessly resume a search for information started on one device (e.g., in a living room on a tablet or desktop computing device), on another user device (e.g., when to heading out the door with a mobile phone).

A user interface is provided that presents personalized past, present, and future aspects related to a search, while the user is entering the query, which are represented in the user interface with the past aspect as a top interactive portion (a historical listing), the present aspect as a middle interactable portion (a query entry field) and the future aspect as a bottom interactable portion (a suggestion listing).

The interactive historical listing displays a chronological listing of recent search history and is scrollable such that the user can interact tactilely using a finger, for example, on a touch-based display to scroll up or down, and make a selection. The history items can also be expandable to disclose additional information of a given previous search by selecting an expander control (“+”).

The user can navigate from the past aspect to the present aspect of the user interface by tapping (touching, or using some other natural user interface (NUI) gesture) the query entry field to employ the active cursor for query entry. Additionally, user query input can be accomplished using different NUI input gesture technologies such as speech, hand, body, body part poses, and so on.

The user can navigate from the present aspect to the future aspect of the user interface by tapping (touching, or using some other NUI gesture) in an area of the suggestion listing to employ the active cursor for query entry. The suggestions in the suggestion listing can be ranked according to many different criteria, such as personal criteria (e.g., user preferences, user location, query type, content type searched, etc.), and socially-generated suggestions of other users, for example. The suggestion listing items can also be expandable to disclose additional information of a given previous search by selecting an expander control (“+”).

The suggestions can further be annotated in the listing with a flag that indicates to the user that the suggestion item is a new suggestion or a previous suggestion. Further annotation can be provided to visual indicate the suggestion is generically-derived from the generic auto-suggestion subsystem or is a personally-derived suggestion item from the personalized auto-suggestion subsystem.

Generally, the architecture describes interaction between user interfaces (e.g., television, desktop computer, smartphone, tablet computer, and other suitable devices) to a backend system. The backend system primarily supports auto-suggestion to discover new information and relevant previous searches. Previous searches of a user are stored in the user's personal repository, as associated with the user's log-in account. This enables the user to record all historical searches and provide a seamless search experience across devices. Other personally identifiable data can be used such as assigned identifiers, for example. This enables the storage of all user historical searches and a seamless search experience across devices.

User search history data flows through the auto-suggestion technology, which takes a user entry as input and provides at least a relevant previous search as output. At the same time, suggestions from a search index, which has indexed data for the entire web, flows through similar auto-suggestion technology and provides the user new information/suggestions (also referred to a future/discover suggestions). This generic module also takes user entry as input and outputs one or more suggestions.

When the user query arrives at the backend system both future and historical suggestion generation occurs in parallel and at the same time. Output provided by the backend system also annotates a suggestion with a new or a previous flag, which helps the user interface render suggestions relative to a “present” section.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system that enables a responsive input architecture.

FIG. 3 illustrates a set of user interface generalizations of the past, present, and future aspects of the user interface.

FIG. 4 illustrates a diagram of the past, present, and future aspects of the user interface for the device.

FIG. 5 illustrates a search example flow diagram for a tablet computing device.

FIG. 6 illustrates a method in accordance with the disclosed architecture.

FIG. 7 illustrates an alternative method in accordance with the disclosed architecture.

FIG. 8 illustrates a block diagram of a computing system that executes the responsive input architecture in accordance with the disclosed architecture.

### DETAILED DESCRIPTION

The disclosed architecture is a responsive input architecture that provides an intuitive and consistent layout and organization for search input across many different types of devices. The organization provides predictability not found in current implementations across search engine products. The architecture is consistent for all devices thereby enabling a user to seamlessly continue a search for information started on one device (e.g., in a living room on a tablet or desktop computing device), on another user device (e.g., when to heading out the door with a mobile phone). For example, using a tablet computing device for searching while in a living room of the user residence, the same user can thereafter rediscover the search information and resume the search session on a mobile device while in the house or away from the residence.

The responsiveness aspect of the architecture enables scaling across multiple devices such as televisions, desktop computers, tablet computers, and mobile phone devices, and the like. The responsive input architecture provides predictability as user tasks extend over time and multiple devices. The architecture provides a consistent schema for searching for new information and the filtering of previous searches. This enables a discoverable entry point and efficient way to find information. The architecture introduces an input row that enables a user to switch between different media technologies such as text, voice, and camera. Entering text or using voice filters history at the same time as providing automatically generated suggestions (“auto-suggestions”).

User interaction can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

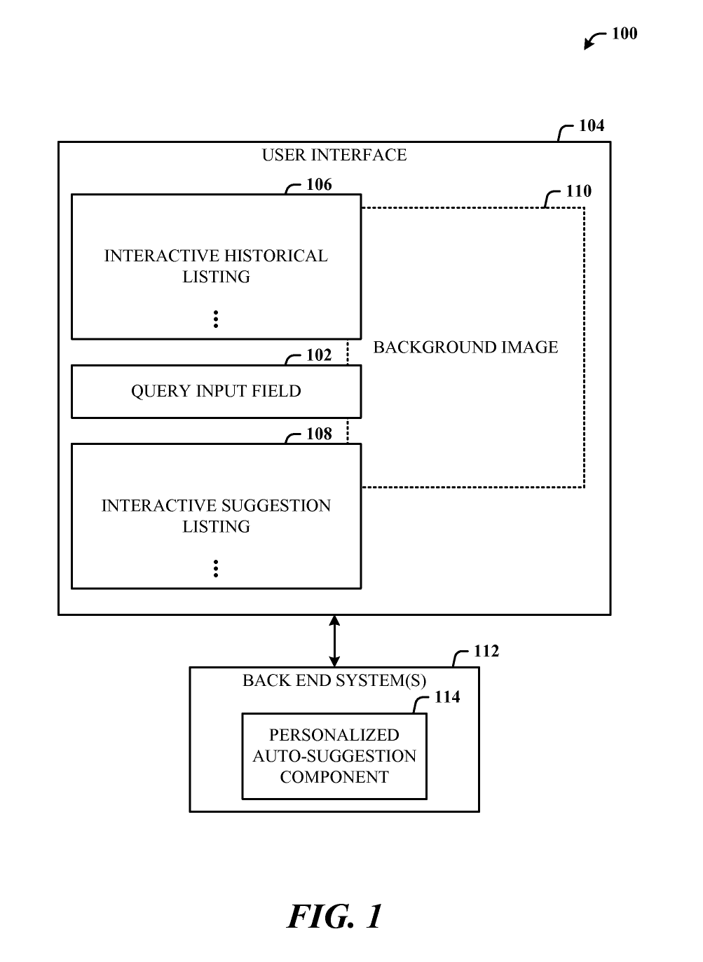

FIG. 1 illustrates a system 100 in accordance with the disclosed architecture. The system 100 can include a query input field 102 of a search user interface (UI) 104 for receiving a query, an interactive historical listing 106 of previous queries of the search user interface 104 presented proximate the query input field 102, and an interactive suggestion listing 108 of suggested queries the search user interface 104 presented proximate the query input field 102, when suggestions are available. In other words, the auto-suggestion listing will not be shown if no suggestions are available, but will be presented once at least one suggestion is available and can be presented in the suggestion listing 108.

As structured in the UI 104 in a top-down manner, for example, where the historical listing 106 is above the input field 102, and the suggestion listing 108 is below the input field 102, the user is presented with a time-ordered schema (top-down as past, present, future) that is readily identifiable and intuitive. Moreover, the schema is designed to be presented the same way across the many devices a user can access, such as a desktop computer, laptop computer, tablet computer, mobile device (e.g., cell phone), gaming unit where the unit is Internet connected and can be used as to display the search schema on the television, and so on.

The interactive historical listing 106 and the interactive suggestion listing 108 are scrollable lists that operate independent of each other. That is, the user can chooses to scroll the historical listing, and then navigate to scroll the suggestion listing 108. If suitably implemented for multiple types of user input (e.g., text, voice, camera, etc.), as is achievable with natural user interface (NUI) technologies, the user may navigate the historical listing while concurrently navigating the suggestion listing.

The input field 102 enables selection of a user input technology from multiple input types. The user can choose for simple text input, voice input, and/or image recognition input. The historical listing 106 and the suggestion listing 108 are filtered as parts of the query are input in the query input field. As the user sequentially enters characters of the search query, the architecture operates on the characters input up to at any point in time to filter the stored historical results. Concurrently with character input, the suggestions in the suggestion listing are being generated and presented based on the characters input up to a specific point in time of the query entry.

The historical listing 106 and the suggestion listing 108 are presented and visually updated as characters of the query are input into the query input field. As described above with filtering, as the user sequentially enters characters of the search query, the architecture operates on the characters input up to at any point in time to derive historical queries and suggested queries for presentation. Concurrently with character input and historical query listing, the suggestions in the suggestion listing are being generated and presented.

The suggestion listing 108 is presented only when a recognized suggestion is computed to be shown. If no suggestions have been computed, there is no need to allocate and consume display space of the device until such time a suggestion can be available for presentation. The query input field 102 is locked into a predetermined location of the user interface 104 when the suggestion listing 108 is scrolled. In one implementation, the input field 102 moved into position and is locked at the top of UI 104.

It can be the case that the user is provided the capability via the UI 104 (or other device programs) to change the positioning of the input field 102, historical listing 106, and suggestion listing 108. For example, the user can be provided the configurable capability to move the suggestion listing 108 above the input field 102, and the historical listing 106 below the input field 102. Alternatively, the input field 102 can be located above both listings (106 and 108), with the suggestion listing 108 directly underneath the field 102, followed by the historical listing 106 on the bottom of the column structure of objects. Where the device being used has a wide display, the user can reposition (e.g., drag-and-drop) the objects in a row fashion such as the input field 102 on the left, followed by the suggestion listing 108 on the immediate right of the field 102, and then the historical listing 106 at the end of the row. These are simply a few examples of how the objects (input field 102, historical listing 106, and suggestion listing 108) can be oriented as desired on a per-device basis.

The user interface 104 can also show a background image 110 that corresponds to a related historical query. For example, if the historical query was related a specific type of automobile, and the user hovers over the related query in the historical listing 106, the system 100 automatically presents the image 110 in the background so the user may be readily perceive or have a better idea of what the previous query was about. It is to be appreciated that for each query listing in the historical listing 106, there can be an image or some other form of multimedia selected, stored, and presented or played (e.g., audio, video) for perception by the user. The type of multimedia stored and related to the historical query can be content selected by the user during a search session, ultimately arrived to by the user at the end of the search session, or a system-generated content (e.g., based on related user profile preferences), for example.

Accordingly, the system 100 can employ a backend system 112 (of one or more subsystems) that comprises an auto-suggestion component that includes a personalized auto-suggestion component 114 which generates personalized suggestions for the suggestion listing 108 based on user search history and user search behavior.

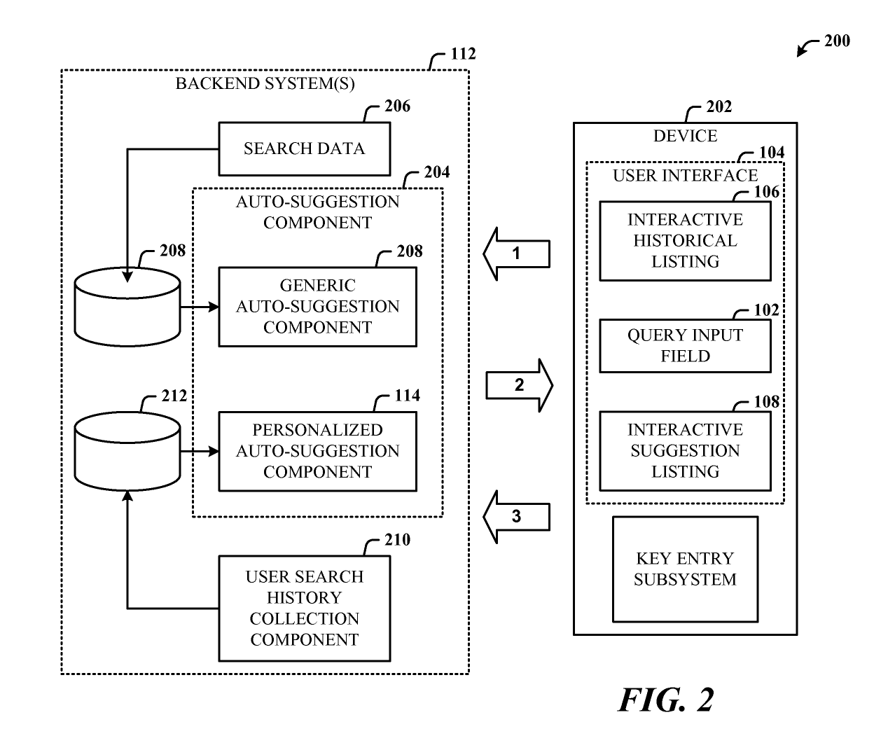

FIG. 2 illustrates a system 200 that enables a responsive input architecture. The system 200 describes interaction between a device 202 (e.g., a television, desktop computer, tablet computer, mobile phone, etc.) capable of operating the user interface 104, and the backend system 112. The backend system 112 can be part of a search engine, or external to but associated with (interfacing to) the search engine. The backend system 112 supports auto-suggestion (via an auto-suggestion component 204) to discover new information and relevant previous searches.

Generally, the system 200 describes interaction between user interfaces (e.g., television, desktop computer, smartphone, tablet computer, and other suitable devices) to the backend system 112. The backend system 112 primarily supports auto-suggestion to discover new information and relevant previous searches. Previous searches of a user are stored in the user's personal repository, as associated with the user's log-in account. This enables the user to record all historical searches and provide a seamless search experience across devices. Other personal identify data can be used such as assigned identifiers, for example. This enables the storage of all user historical searches and a seamless search experience across devices.

User search history data flows through the auto-suggestion technology, which takes a user entry as input and provides at least a relevant previous search as output. At the same time, suggestions from a search index, which has indexed data for the entire web, flows through similar auto-suggestion technology and provides the user new information/suggestions (also referred to a future/discover suggestions). This generic module also takes user entry as input and outputs one or more suggestions. When the user query arrives at the backend system 112 both future and historical suggestion generation occurs in parallel and at the same time. Output provided by the backend system 112 also annotates a suggestion with a new or a previous flag, which helps the user interface render suggestions relative to a “present” section (also referred to as active cursor or query entry field). The auto-suggestion component 204 provides an effective mechanism for generating relevant suggestions for a given user query using search engine caching, prefix-infix matching, ranking, and relevance technology.

In operation, when the user enters a query in the input field 102 of the user interface 104, the query is sent to (Arrow 1) and processed by the search engine (not shown) and backend system 112. Search data 206 is obtained from all users that perform searches, and the search data 206 is stored in a generic repository 208. A user search history collection component 210 stores search history specific to the user of the device 202 (e.g., a smartphone) in a personalized repository 212 based on searches performed using the device 202 and other related user devices (e.g., desktop computer, laptop computer, etc.).

The auto-suggestion component 204 then operates on both of the generic repository 208 and the personalized repository 212 to return the interactive suggestion listing 108 to the user interface 104. The suggestions returned from the backend system 112 (Arrow 2) include both new and historical suggestions. The auto-suggestion component 204 comprises a generic auto-suggestion component 214 and the personalized auto-suggestion component 114. The generic auto-suggestion component 214 operates on data of the generic repository 208, and the personalized auto-suggestion component 114 operates on data of the personalized repository 212. Suggestion generation from both the generic auto-suggestion component 214 and the personalized auto-suggestion component 114 is performed in parallel and concurrently.

It is to be understood that in such systems that handle massive amounts of data, an offline processing component (not shown) of the backend system 112 is provided that continuously consumes the data from the personalized and/or generic repository(ies) and generates the data in the format needed to give the suggestions output, when a query comes in. This component utilizes the auto-suggest technology, and is used for data processing for both the generic search data and personalized user data.

When the user selects a suggestion (future or historical) from the suggestion listing 108, the selected suggestion is noted and passed (Arrow 3) into the user search history collection component 210 to be stored and considered in future query and suggestion processing.

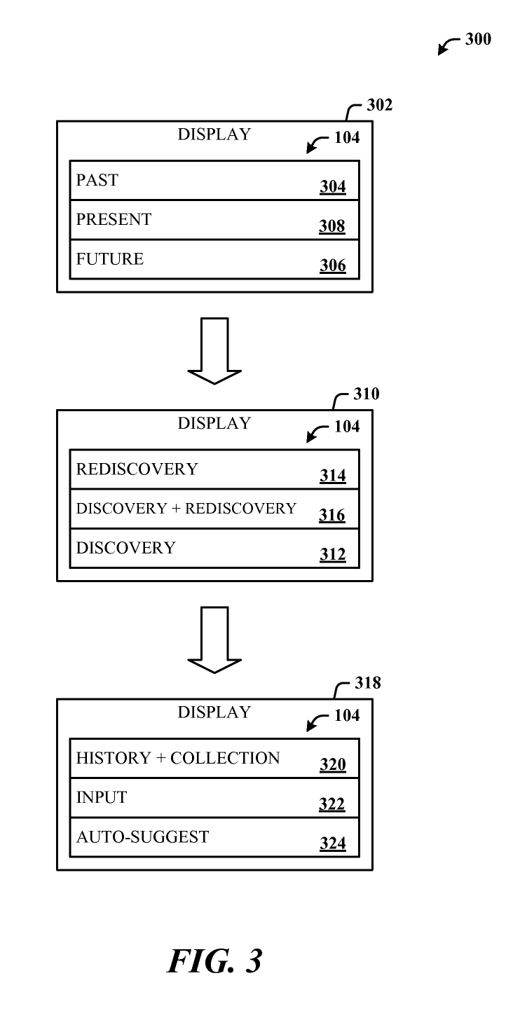

FIG. 3 illustrates a set of user interface generalizations 300 of the past, present, and future aspects of the user interface 104. At a high level, the layout and architecture can be illustrated into the following time-based schema across devices. In a first display presentation 302, a past section 304 and a future section 306 act as independently scrollable lists giving the user the ability to view all contents of the history list and/or auto-suggestions list while inputting a query. A present section 308 (the input row) contains an active cursor for the user to immediately start entering input or switch between text, voice, or camera input, for example.

Similar to time mapping, as shown in second display presentation 310, the layout of user interface 104 maps to the discovery 312 (new information or present and future) and rediscovery 314 (past or already retrieved) information. The present section 308 maps to both discovery and rediscovery 316. This time-based approach to laying out the information in the user interface 104 provides to the user predictability and ease of locating previous searches. Moreover, as shown in third display presentation 318, features for completing search tasks (e.g., history, collections, input, and auto-suggest) map into this layout—the past section 304 maps to history and collection 320, the present section 308 maps to input 322, and the future section 306 maps to auto-suggest 324.

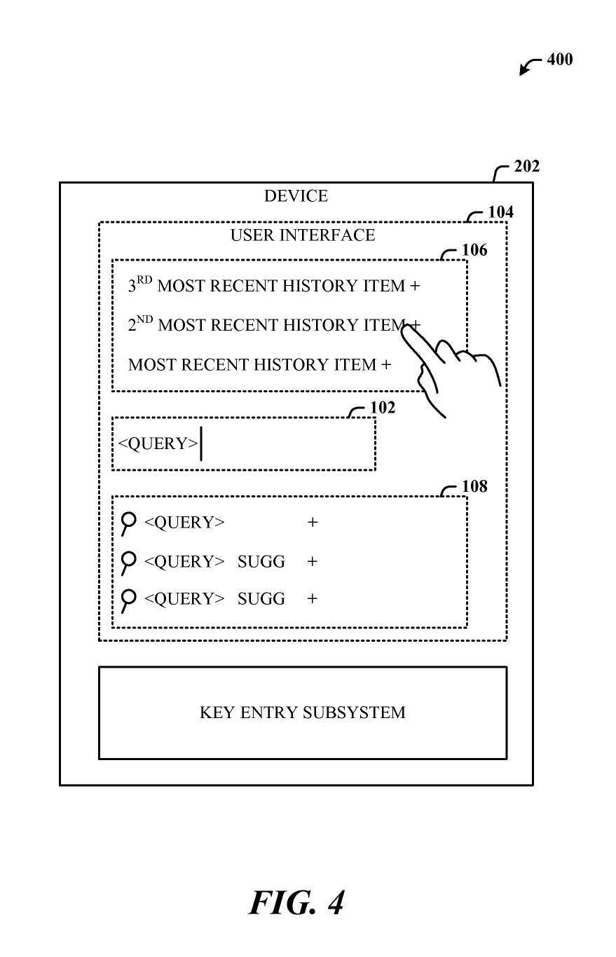

FIG. 4 illustrates a diagram 400 of the past, present, and future aspects of the user interface 104 for the device 202. The past, present and future aspects of the disclosed architecture are represented in the user interface 104 with the past aspect as a top interactable portion (the historical listing 106), the present aspect as a middle interactable portion (the query entry field 102) and the future aspect as a bottom interactable portion (the suggestion listing 108).

The interactive historical listing 106 (the past aspect) displays a chronological listing of recent search history. Here, the historical listing 106 shows the oldest history item on top (“3^{rd} most recent . . . ”) and the most recent history item on the bottom (“most recent . . . ”). The historical listing 106 is scrollable such that the user can interact tactilely using a finger on a touch-based display to scroll up or down, and make a selection. The history items can also be expandable to disclose additional information of a given previous search by selecting an expander control (“+”).

The user can navigate from the past aspect to the present aspect of the user interface 104 by tapping (touching, or using some other NUI gesture) the query entry field to employ the active cursor for query entry. Additionally, user query input can be accomplished using different NUI input gesture technologies such as speech, had poses, and so on. The user can navigate from the present aspect to the future aspect of the user interface 104 by tapping (touching, or using some other NUI gesture) in an area of the suggestion listing 108 to employ the active cursor for query entry. The suggestions in the suggestion listing 108 can be ranked according to many different criteria, such as personal criteria (e.g., user preferences, user location, query type, content type searched, etc.), and socially-generated suggestions of other users, for example.

The suggestion listing items can also be expandable to disclose additional information of a given previous search by selecting an expander control (“+”). The suggestions can further be annotated in the listing 108 with a flag that indicates to the user that the suggestion item is a new suggestion or a previous suggestion. Further annotation can be provided to visual indicate the suggestion is generically-derived from the generic auto-suggestion subsystem or is a personally-derived suggestion item from the personalized auto-suggestion subsystem.

The device 202 can employ a privacy component (not shown) for authorized and secure handling of user information. The privacy component enables the user to opt-in and opt-out of using user input such as from queries, selected future or past items, and so on.

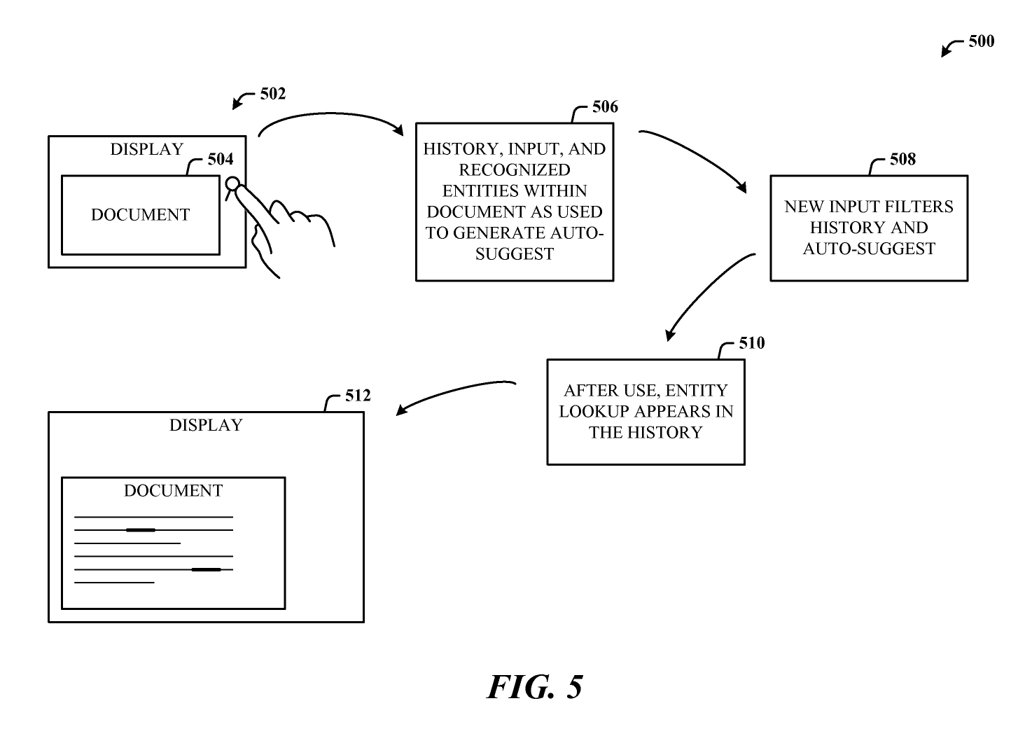

FIG. 5 illustrates a search example flow diagram 500 for a tablet computing device. At 502, a search is initiated while viewing a document 504 in a local client application, by selecting a search control. At 506, history data, input data, and recognized entities in the document 504 are used to generate auto-suggestions. At 508, new input is used to filter history and auto-suggest. At 510, after initial use, entity lookup appears in the history section of the user interface. At 512, engaging with the entity in the historical listing can open a panel and highlight in the application to show correlation.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

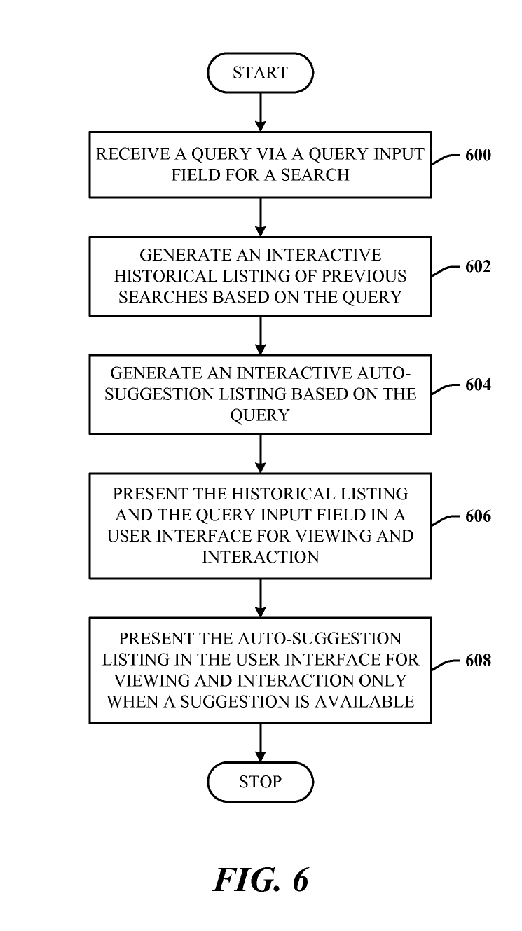

FIG. 6 illustrates a method in accordance with the disclosed architecture. At 600, a query is received via a query input field of a user interface of a first device for a search. At 602, an interactive historical listing of previous searches is generated based on the query. The listing can be presented in a chronological order (e.g., reverse) relative to the input field. At 604, the historical listing and the query input field are presented in the user interface for viewing and interaction.

At 606, an interactive auto-suggestion listing is generated and presented in the user interface for viewing and interaction only when a suggestion is available. If no suggestion has been generated, there is no need to present the suggestion listing. Thus, it can be the case that the historical listing appears in the user interface before, if at all, the suggestion listing is presented.

At 608, rediscovery of the search is enabled on a second device by presenting the query input field, the interactive historical listing, and interactive auto-suggestion listing on the second device. Rediscovery is enabled since the historical listing and suggestion listing are both associated to specific user login credentials. Thus, when the user employs the same login credentials on a second user device, the user interface and listings are restored on that second device when initiating a search session.

The method can further comprise enabling navigation of the historical listing and the auto-suggestion listing independent of each other. The user can scroll through historical listing items of the historical listing for viewing without affecting the suggestion listing. Similarly, the user can scroll through suggestion items of the suggestion listing for viewing without affecting the historical listing.

The method can further comprise presenting the user interface on multiple devices of a user so the search can be continued from one device to another device. This is enabled when the user logs in using the same credentials as on another user device.

The method can further comprise personalizing the historical listing and the auto-suggestion listing based on browsing habits and query history of a user. This capability provides a more useful, effective, and pleasant search user experience for the user, since some or all of the suggestions and previous search history are related to user interests.

The method can further comprise automatically updating at least one of the historical listing or the auto-suggestion listing as the query is being input. The method can further comprise enabling selection of at least one of text input, voice input, or camera input in association with the query input field. This can occur on a character-by-character basis of query entry. When using a camera input, this updating can be performed using face recognition of the user, for example. More specific image analysis can be employed to recognize (via recognition processing) image features and updating based on these features. For example, if a recognized image feature is a mountain landscape and the user geographical coordinates location is known, the suggestions can be related to the mountain and points of interest nearby or of the area. By way of the microphone, speech recognition can be used to update suggestion content. Moreover, audio signals (e.g., music) can be analyzed to ascertain the audio content and perform suggestion and historical updates related to the content.

The method can further comprise enabling repositioning of the query input field to view either more items of the historical listing or the auto-suggestion listing. If the user is more interested in the suggestions, the input field can be dragged to expose more suggestion listings. Similarly, if the user is more interested in the previous search queries, the input field can be dragged to expose more historical list items.

The method can further comprise annotating a suggestion as new or previous to render the suggestion in the user interface relative to the query input field. The backend system auto-suggestion component can perform this annotation to assist in the rendering of the suggestions in a ranked order and or a chronological order, for example. If a new suggestion, the user may be more inclined to select the new suggestion rather than a previously viewed suggestion. However, if a previous suggestion, the user may also so choose this suggestion to rediscover prior search items of interest.

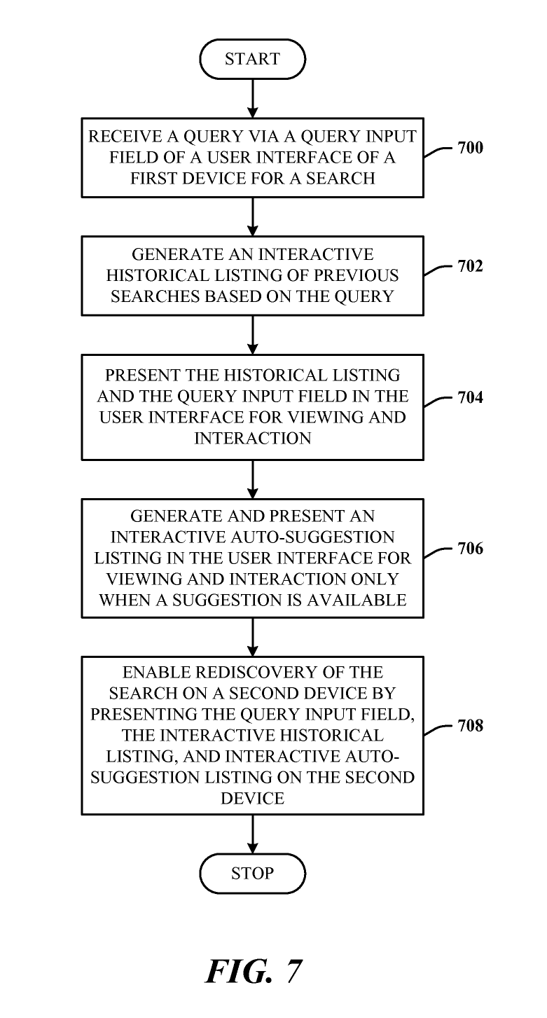

FIG. 7 illustrates an alternative method in accordance with the disclosed architecture. At 700, a query is received via a query input field of a user interface of a first device for a search. At 702, an interactive historical listing of previous searches is generated based on the query. At 704, the historical listing and the query input field are presented in the user interface for viewing and interaction. The generation, ordering, and presentation aspects can be performed by the backend systems (and search engine). Thus, the device user interface presents these presentation aspects as received from the online backend system. The backend system can be a cloud-based system that stores and processes information for access by the many user devices and according to the specific user login credentials.

At 706, an interactive auto-suggestion listing is generated and presented in the user interface for viewing and interaction only when a suggestion is available. The backend system includes the auto-suggestion component for personalized and generic auto-suggestion creation. At 708, rediscovery of the search on a second device is enabled by presenting the query input field, the interactive historical listing, and interactive auto-suggestion listing on the second device.

The method can further comprise enabling navigation of the historical listing and the auto-suggestion listing independent of each other. The method can further comprise personalizing the historical listing and the auto-suggestion listing based on browsing habits and query history of a user. The method can further comprise presenting items of the historical listing chronologically.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

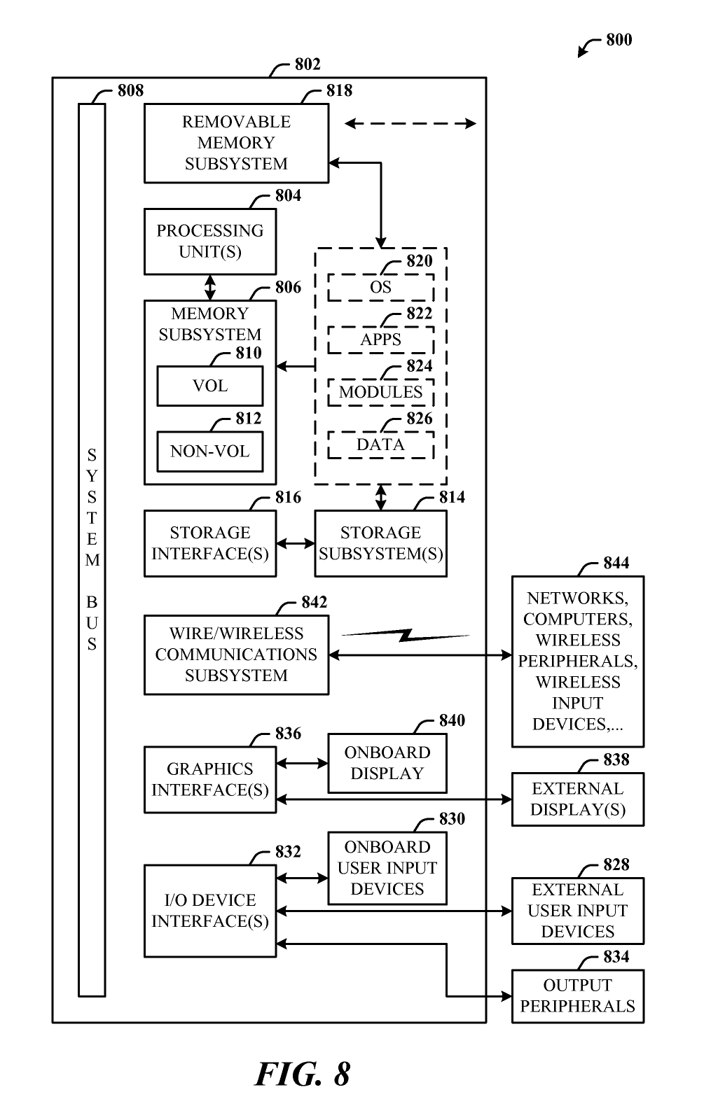

Referring now to FIG. 8, there is illustrated a block diagram of a computing system 800 that executes the responsive input architecture in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804 (also referred to as microprocessor(s) and processor(s)), a computer-readable storage medium such as a system memory 806 (computer readable storage medium/media also include magnetic disks, optical disks, solid state drives, external memory systems, and flash memory drives), and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include items and components of the system 100 of FIG. 1, items and components of the system 200 of FIG. 2, the generalizations 300 of FIG. 3, the diagram 400 of FIG. 4, the flow diagram 500 of FIG. 5, and the methods represented by the flowcharts of FIGS. 6 and 7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example.

These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a query input field of a user interface for receiving a query;
an interactive historical listing of previous queries of the user interface presented proximate the query input field;
an interactive suggestion listing of suggested queries, the suggestion listing presented proximate the query input field of the user interface when a suggestion is available; and
at least one microprocessor that executes computer-executable instructions associated with the input field, the interactive historical listing, and the interactive suggestion listing.

2. The system of claim 1, wherein the interactive historical listing and the interactive suggestion listing are scrollable lists that operate independent of each other.

3. The system of claim 1, wherein the input field enables selection of a user input technology from multiple input types.

4. The system of claim 1, wherein the historical listing and the suggestion listing are filtered as parts of the query are input in the query input field.

5. The system of claim 1, wherein the historical listing and the suggestion listing are presented and visually updated as characters of the query are input into the query input field.

6. The system of claim 1, wherein a suggestion received for the suggestion listing is annotated as new or previous to facilitate rendering of the suggestion relative to the query input field.

7. The system of claim 1, wherein the query input field is locked into a predetermined location of the user interface when the suggestion listing is scrolled.

8. The system of claim 1, further comprising a personalized auto-suggestion component that generates suggestions for the suggestion listing based on user search history and user search behavior.

9. A method, comprising acts of:
receiving a query via a query input field for a search;
generating an interactive historical listing of previous searches based on the query;
generating an interactive auto-suggestion listing based on the query;
presenting the historical listing and the query input field in a user interface for viewing and interaction; and
presenting the auto-suggestion listing in the user interface for viewing and interaction only when a suggestion is available.

10. The method of claim 9, further comprising enabling navigation of the historical listing and the auto-suggestion listing independent of each other.

11. The method of claim 9, further comprising presenting the user interface on multiple devices of a user so the search can be continued from one device to another device.

12. The method of claim 9, further comprising personalizing the historical listing and the auto-suggestion listing based on browsing habits and query history of a user.

13. The method of claim 9, further comprising automatically updating at least one of the historical listing or the auto-suggestion listing as the query is being input.

14. The method of claim 9, further comprising enabling selection of at least one of text input, voice input, or camera input in association with the query input field.

15. The method of claim 9, further comprising enabling repositioning of the query input field to view either more items of the historical listing or the auto-suggestion listing.

16. The method of claim 9, further comprising annotating a suggestion as new or previous to render the suggestion in the user interface relative to the query input field.

17. A computer-readable medium comprising computer-executable instructions that when executed by a processor, cause the processor to perform acts of:
receiving a query via a query input field of a user interface of a first device for a search;
generating an interactive historical listing of previous searches based on the query;
presenting the historical listing and the query input field in the user interface for viewing and interaction;
generating and presenting an interactive auto-suggestion listing in the user interface for viewing and interaction only when a suggestion is available; and
enabling rediscovery of the search on a second device by presenting the query input field, the interactive historical listing, and interactive auto-suggestion listing on the second device.

18. The computer-readable medium of claim 17, further comprising enabling navigation of the historical listing and the auto-suggestion listing independent of each other.

19. The computer-readable medium of claim 17, further comprising personalizing the historical listing and the auto-suggestion listing based on browsing habits and query history of a user.

20. The computer-readable medium of claim 17, further comprising presenting items of the historical listing chronologically.
